(19) United States
(12) Patent Application Publication
(10) Pub. No.: US 2012/0024733 A1
(43) Pub. Date: Feb. 2, 2012

(54) PROTECTIVE ELEMENT AND SUPPORT STRUCTURE

(75) Inventors: Steve I. Hwang, San Francisco, CA (US); Christopher C. Jones, San Francisco, CA (US)

(73) Assignee: OpenPeak Inc., Boca Raton, FL (US)

(21) Appl. No.: 12/845,571

(22) Filed: Jul. 28, 2010

(51) Int. Cl. B65D 85/00; G06F 1/16; F16M 13/00

(52) U.S. Cl. 206/320; 248/346.01; 361/679.21

(57) ABSTRACT

A protective apparatus is disclosed. The apparatus includes a protective element for positioning over at least a portion of a device to protect the device in a first configuration. A support structure integral with the protective element also forms part of the apparatus. The support structure is configured to support the device in a second configuration. In one arrangement, the protective element includes a first surface and a second surface in which the first surface is configured to be at least partially positioned over and to face the device in the first configuration. The second surface is positioned opposite to the first surface and is configured to be exposed to the environment external to the device in the first configuration. In another arrangement, the support structure includes a slot that runs along the second surface in which the slot is configured to receive the device in the second configuration.

### FIELD OF TECHNOLOGY

The subject matter herein is directed to devices that are used to protect sensitive equipment.

### BACKGROUND

In recent years, there has been an explosion in the number of available electronic devices, many of which are portable. These portable devices are typically constructed to withstand normal wear and tear, such as accidental drops or slight water intrusions. Nevertheless, many manufacturers and downstream retailers offer components for use with these portable devices that provide protection for the portable devices. For example, many users of smart phones purchase rubber, plastic or leather casings that fit around the device to protect it from accidental impacts. The utility of current protective components, however, is limited to merely providing a defense against the elements or unintended impacts, as they server no other useful purpose.

### SUMMARY

A protective apparatus is described herein. The apparatus can include a protective element configured to be positioned over at least a portion of a device to protect the device in a first configuration. The apparatus can also include a support structure that is integral with the protective element in which the support structure is configured to support the device in a second configuration. The device can be, for example, a computing device that includes a display. In one arrangement, the protective element includes a first surface and a second surface in which the first surface is configured to be at least partially positioned over and to face the device in the first configuration. The second surface can be positioned opposite to the first surface and is configured to be exposed to the environment external to the device in the first configuration.

As an example, the support structure can be a slot that runs along the second surface in which the slot is configured to receive the device in the second configuration. The slot can include a first edge and a second edge opposite to one another in which the first edge and the second edge are positioned a predetermined distance apart. This predetermined distance can be wide enough to receive and support the device in the second configuration and to induce the device to lean at an angle in the second configuration with respect to a vertical axis.

The protective apparatus can also include one or more border protrusions that are substantially perpendicular to a portion of the first surface. These border protrusions can be configured to fit over a corresponding perimeter of the device to assist in an engagement between the protective element and the device in the first configuration.

In one embodiment, the second surface of the protective element transitions upwards from the border protrusions of the protective element towards the first edge and the second edge of the slot. The slot can also include a bottom surface that is substantially planar and can further include a maximum height and a minimum height such that the first edge and the second edge of the slot transition between the maximum height and the minimum height. As an example, the maximum height of the slot is high enough to support the device in the second configuration by inducing the device to lean at an angle in the second configuration with respect to a vertical axis. As another example, the slot runs the entire second surface and is positioned along a horizontal axis of the protective element. The first surface can include one or more ribs to support the protective element, and the ribs can be configured to provide spacing in the first configuration in which one of the ribs corresponds to the slot.

Another protective apparatus for protecting a device is described herein. This apparatus can include a first surface that is configured to at least partially fit over and face the device in a first configuration and a second surface opposite the first surface that is configured to face an external environment in the first configuration. This apparatus can also include a support structure that is integral with the second surface in which the support structure can be configured to engage and support the device in a second configuration. As an example, the support structure is a slot that runs along a horizontal axis of the second surface and has a predetermined width. The predetermined width of the slot can be set to induce the device to lean at an angle in the second configuration in which the angle is measured with respect to a vertical axis. In one particular example but without limitation, the angle is within a range of approximately ten degrees to approximately twenty-five degrees.

In one aspect, the first surface can include one or more ribs, one of which corresponds to the slot. The protective apparatus can further include one or more border protrusions that are configured to engage a corresponding perimeter of the device. The border protrusions can form a continuous lip that creates a perimeter of the protective apparatus.

In another aspect, the support structure can further provide a grasping mechanism for a user to remove the protective apparatus from the device in the first configuration. For example, the support structure is a slot integral with the second surface in which the slot has a bottom surface, a first edge and a second edge. The bottom surface, the first edge and the second edge can form the grasping mechanism of the support structure in the first configuration and engage and support the device in the second configuration.

A protection and support system is also described herein. The system includes a device that has an interface for displaying information to a user and a protective apparatus configured to protect the device in a first configuration and support the device in a second configuration. The interface displays the information in the second configuration. The protective apparatus includes a first surface that is at least partially positioned over the interface in the first configuration, a second surface that is exposed to the environment external to the device in the first configuration and a support structure integral with the second surface that engages and supports the device in the second configuration. As an example but without limitation, the device is a communication device that includes a camera for conducting video conference calls in the second configuration.

The support structure can include a slot integral with the second surface that induces the device to lean at an angle with respect to a vertical axis, which causes the interface to also be positioned at an angle with respect to the vertical axis. In one arrangement, the slot has a predetermined width and a maximum height, and the dimensions of the predetermined width and maximum height can be set to induce the device to lean at the angle. In another arrangement, the interface of the device is substantially planar, and the first surface can include one or more ribs for engaging the interface in the first configuration. The slot can also include a grasping mechanism to permit a user to remove the protective apparatus from the device in the first configuration.

A method of protecting and supporting a device with a protective apparatus is also presented herein. The method can include the steps of positioning the protective apparatus over at least a portion of the device such that the protective apparatus is engaged with the device to protect the device in a first configuration and removing the protective apparatus from the device. The method can further include the steps of placing the protective apparatus on a surface and in a second configuration, engaging the device with a support structure that is integral with the protective apparatus. Engaging the device with the support structure can include fitting a portion of the device into a slot built into the protective apparatus, and the slot can induce the device to lean at an angle with respect to a vertical axis. Removing the protective apparatus from the device can include at least partially grasping the slot and lifting the protective apparatus away from the device. The method can also include the step of conducting a video conference call in the second configuration.

### BRIEF DESCRIPTION OF THE DRAWINGS

Embodiments of the present application will now be described, by way of example only, with reference to the attached Figures, wherein:

FIG. 1 illustrates an example of a protection and support system;

FIG. 2 illustrates an example of a protective element engaged with a device in first configuration;

FIG. 3 illustrates an example of a surface of the protective element of FIG. 2;

FIG. 4 illustrates an example of a side view of the protective element of FIG. 2;

FIG. 5 illustrates an example of the protective element of FIG. 2 supporting the device of FIG. 2 in a second configuration; and

FIG. 6 illustrates an example of a side view of the second configuration of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this document will now be presented. A “protective element” or “protective apparatus” is defined as an element that provides some form of protection for a device from an external environment. The terms “external environment” or “environment external to a device” are defined as the physical surroundings of a device, whether it be inside a building or a covered or exposed area. The word “configuration” means a state of positioning. A “support structure” is defined a structure that provides mechanical support to a device in a static or substantially static state. A “slot” is an elongated channel, depression, groove or aperture for receiving an object. The word “edge” is defined as one or more surfaces that serve as a border at which one or more other surfaces terminate. The phrase “to induce” means to bring about, produce or cause through structural configurations or designs. The term “interface” is defined as a device that displays or presents information to a user of the device. A “camera” is defined as a device that captures a sequence of images for display, and a “video conference call” is a communication in which the image of one or more parties involved in the communication is displayed to one or more of the other parties on the communication. A “grasping mechanism” is defined as a component or a group of components associated with a device, and the component(s) provide one or more surfaces or objects to enable a human to grasp the device with his hand.

As noted earlier, components have been developed to protect electronic devices, such as flexible casings or covers. Unfortunately, the utility of these components is merely limited to protecting the devices to which they are associated. The description here provides several features to increase the utility and convenience of a protective apparatus. In particular, a protective apparatus is presented in which the apparatus includes a protective element for positioning over at least a portion of a device to protect the device in a first configuration. A support structure integral with the protective element can also form part of the apparatus. The support structure can be configured to support the device in a second configuration. In one arrangement, the protective element includes a first surface and a second surface in which the first surface is configured to be at least partially positioned over and to face the device in the first configuration. The second surface can be positioned opposite to the first surface and can be configured to be exposed to the environment external to the device in the first configuration. In another arrangement, the support structure includes a slot that runs along the second surface in which the slot is configured to receive the device in the second configuration.

As such, this protective apparatus can provide protection for the device when engaged with the device and can support the device when certain features of the device call for a particular positioning. For example, the apparatus can support a communication device when a user of the device is involved in a video conference call. Moreover, as will be explained below, the protective apparatus, through the support structure, provides a mechanism for grasping the apparatus for easy removal from the device. Thus, the protective apparatus is a convenient and useful tool, particularly in comparison to conventional protective components.

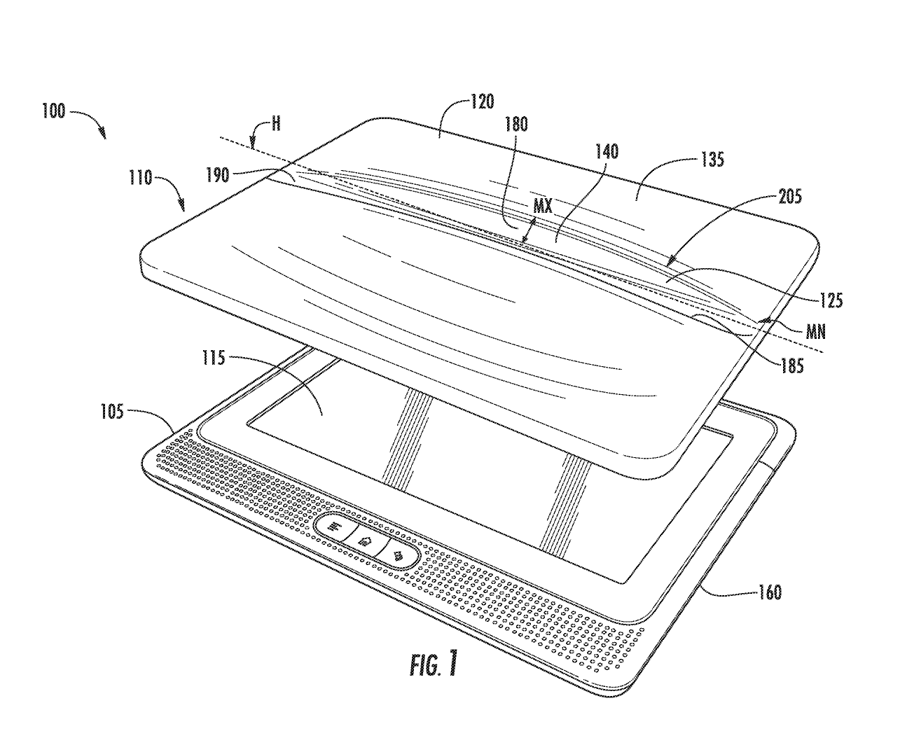

Referring to FIG. 1, a protection and support system 100 is shown in which the system includes a device 105 and a protective apparatus 110. The device 105 can be an electronic device, such as a computing device, and can have a substantially planar interface 115 for displaying information to a user. Suitable examples of the computing device include tablets, wireless reading units, mobile phones and entertainment or multi-media devices. It is understood, however, that the device 105 is not necessarily limited to an electronic device, as the device 105 can be virtually any physical unit that needs to be protected in one state and supported in another state. For example, the device 105 may be a hardcover or paperback book that the reader wants to protect from the elements when being transported and can be supported by the protective apparatus 110 in a suitable reading position. Thus, the interface 115 may be a conventional display, but it may also be a page or some other non-electronic structure that shows information to a user.

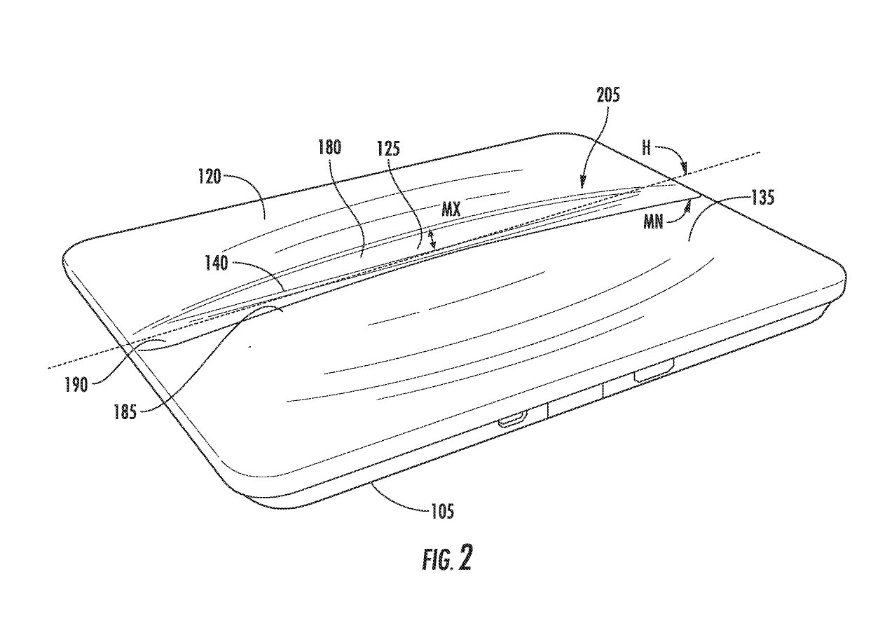

The protective apparatus 110 can be a protective element 120 that is configured to be positioned over at least a portion of the device 105 in a first configuration. Referring to FIG. 2, an example of the protective element 120 positioned over the device 105 in the first configuration is shown. The first configuration refers to any state of engagement between the protective element 120 and the device 105 in which the protective element 120 is positioned to provide some form of protection for the device 105. In this particular example, the protective element 120 can protect the interface 115 (see FIG. 1) and other components of the device 105 from the elements, like rain, snow or sun, or any environment that is external to the device 105. In addition to protection from weather-related events, the protective element 120 can protect the device 105 from contact that would otherwise damage the device 105.

Although the protective element 120 is shown here as covering the entire interface 115 and other components on a top surface of the device 105, the protective element 120 is not so limited. For example, the protective element 120 can be made smaller to protect only certain areas of the interface 115 or other suitable components of the device 105. Moreover, the protective element 120 can be expanded to cover larger portions of the device 105, as compared to that shown in FIG. 2. For example, the protective apparatus 110 can include other protective elements 120 that can be joined together, such as through a hinge or other connection structures, to envelope the entire device 105. To accomplish its goal of protecting the device 105, the protective element 120 can be made of any suitable material, including combinations of such materials. For example, the protective element 120 can be made of durable plastic, rubber, metal or even wood or other organic components or composites.

In addition to providing protective cover for the device 105, the protective apparatus 110 can include a support structure 125 (see FIGS. 1 and 2) that is integral with the protective element 120. The phrase “integral with” is defined as of, pertaining to or belonging as a part of a whole and includes permanent or detachable connections. As will be described below, the support structure 125 can be configured to engage and support the device 105 in a second configuration.

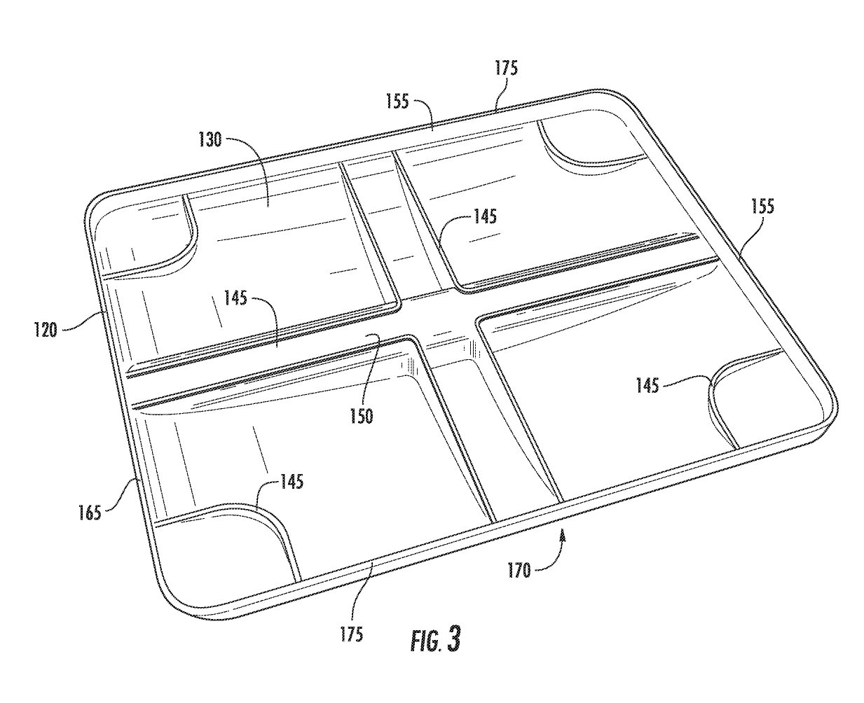

Referring to FIG. 3, another view of the protective element 120 is shown. To further describe the protective element 120, reference will now be made to FIGS. 1-3. In one arrangement, the protective element 120 can include a first surface 130 (best shown in FIG. 3) and a second surface 135 (best shown in FIGS. 1 and 2). In the first configuration (see FIG. 2), the first surface 130 can be at least partially positioned over and face the interface 115 of the device 105. Additionally, the second surface 135 can be positioned opposite to the first surface 130 and can be exposed to the environment external to the device 105 in the first configuration.

As best shown in FIGS. 1 and 2, the second surface 135 can be substantially non-planar. For example, the second surface 135 can be substantially curved in nature, as pictured, although the second surface 135 may take on other suitable shapes. In one arrangement, the support structure 125 can be a slot 140 that, for example, runs along the second surface 135. In one particular example but without limitation, the slot 140 can run the entire length of the second surface 135 of the protective element 120 and can be positioned along a horizontal axis H of the protective element 120. The slot 140 can be configured to receive the device 105 in the second configuration, as will be presented below.

As best shown in FIG. 3, the first surface 130 of the protective element 120 can include one or more ribs 145 to support the protective element 120, and the ribs 145 can also be configured to provide spacing in the first configuration. Specifically, a portion of the first surface 130 can be substantially non-planar, with a curvature that is proportionally similar to that of the second surface 135. In the first configuration, the ribs 145 of the first surface 130 may engage the interface 115 by resting on or slightly above the interface 115 or some other suitable component of the device 105. This design, because the ribs 145 provide support and spacing for the first surface 130, can minimize the amount of material required to form the protective element 120. As an option, one of the ribs 145 can correspond to the slot 140 (see FIGS. 1 and 2). That is, the formation of the slot 140 in the second surface 135 can lead to the generation of a corresponding rib 145. An example of this feature is illustrated by the rib 145 that is the widest of the ribs 145 shown here and that runs along all or most of the first surface 130. This particular rib 145, in view of its additional width, can include a substantially planar surface 150. As another alternative, a cushioning material can be affixed or attached to any of the ribs 145 to further protect the interface 115. In yet another alternative arrangement, the first surface 130 can be made substantially planar or flat, with no exposed ribs 145 or ribs 145 that have minimal height.

To assist in the engagement between the protective element 120 and the device 105, the protective apparatus 110 can include one or more border protrusions 155. In particular, the border protrusions 155 can be configured to engage a corresponding perimeter 160 of the device 105 (see FIG. 1). In one embodiment, the border protrusions 155 can be substantially perpendicular to a portion of the first surface 130, such as the planar surface 150 of one of the ribs 145. As another example, the border protrusions 155 can form a continuous lip 165, which can create a perimeter 170 for the protective apparatus 110. In the first configuration, the border protrusions 155 of the lip 165 can fit around and engage the corresponding perimeter 160 of the device 105 to assist in the engagement between the protective element 120 and the device 105 (see FIG. 2). To further assist in this engagement, some of the border protrusions 155 can include one or more snap fits 175, which can snap onto the perimeter 160 of the device 105. Of course, other mechanisms may be implemented in addition to or in lieu of the snap fits 175 to assist in the engagement.

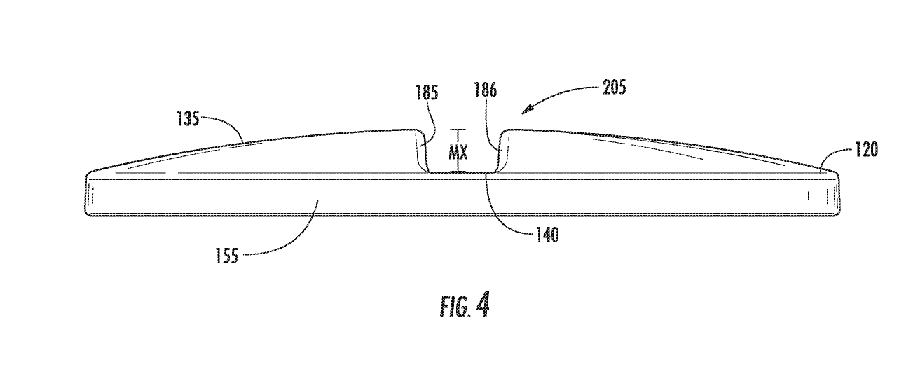

Referring once again to FIGS. 1 and 2, as noted earlier, the support structure 125 can be a slot 140. The slot 140 can include a first edge 180, a second edge 185 and a bottom surface 190. In one arrangement, the first edge 180 and the second edge 185 can be opposite to one another, and the bottom surface 190 can be substantially planar. Also, the first edge 180 and the second edge 185 can be positioned a predetermined distance apart. Referring to FIG. 4, a side view of the protective element 120 is shown. Here, the predetermined width between the first edge 180 and the second edge 185 can be seen.

As can also be seen in FIGS. 1, 2 and 4, the second surface 135, in view of its curvature, can transition upwards from the border protrusions 155 of the protective element 120 towards the first edge 180 and the second edge 185 of the slot 140. Although this transition is shown as being relatively continuous and smooth, the shape of the second surface 135 is certainly not so limited. In fact, more discrete and sudden changes in the height of the second surface 135, like a staircase design, may be employed here. To further enhance its implementation into the second surface 135, the slot 140 (i.e., support structure 125) can essentially track at least a portion of the overall shape of the second surface 135. For example, the slot 140 can include a maximum height M_{X} and a minimum height M_{N} (M_{N} not shown in FIG. 4), and the first edge 180 and the second edge 185 of the slot 140 can transition between the maximum height M_{X} and the minimum height M_{N}.

Although this transition can substantially match that of the second surface 135, the slot 140 is not limited as such. For example, the first edge 180 and the second edge 185 may transition between the maximum height M_{X} and the minimum heights M_{N} through discrete and angular steps. Moreover, the maximum height M_{X} and the minimum heights M_{N} are not necessarily limited to matching the overall maximum and minimum heights of the second surface 135. For example, the maximum height M_{X} of at least a portion of one of or both of the first edge 180 and the second edge 185 can be increased in height such that the maximum height(s) M_{X} exceed that of the second surface 135. This may permit the protective element 120 to provide for greater stability of the device 105 in the second configuration.

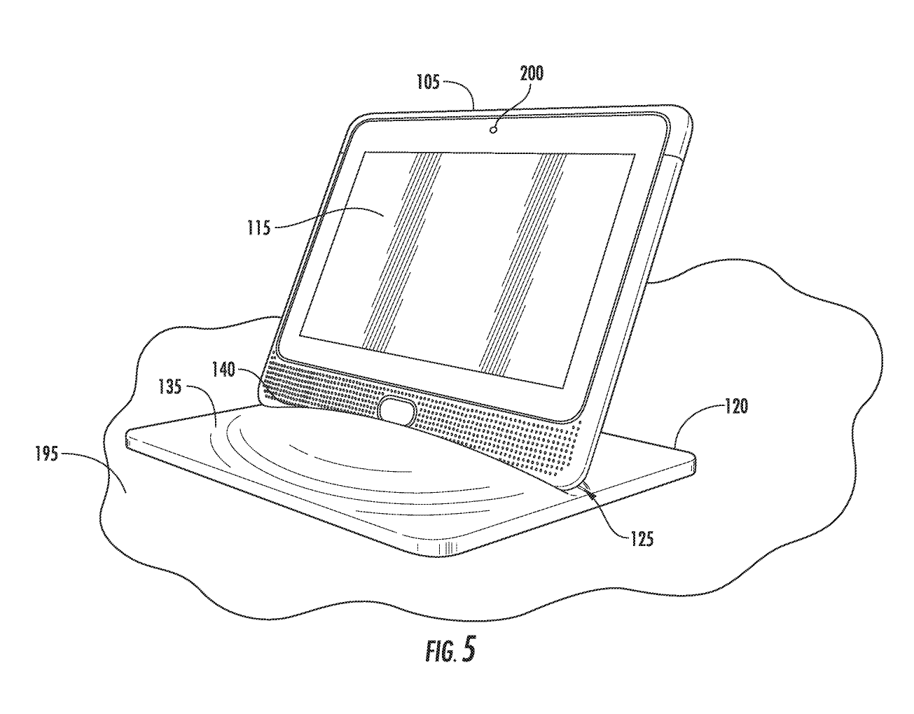

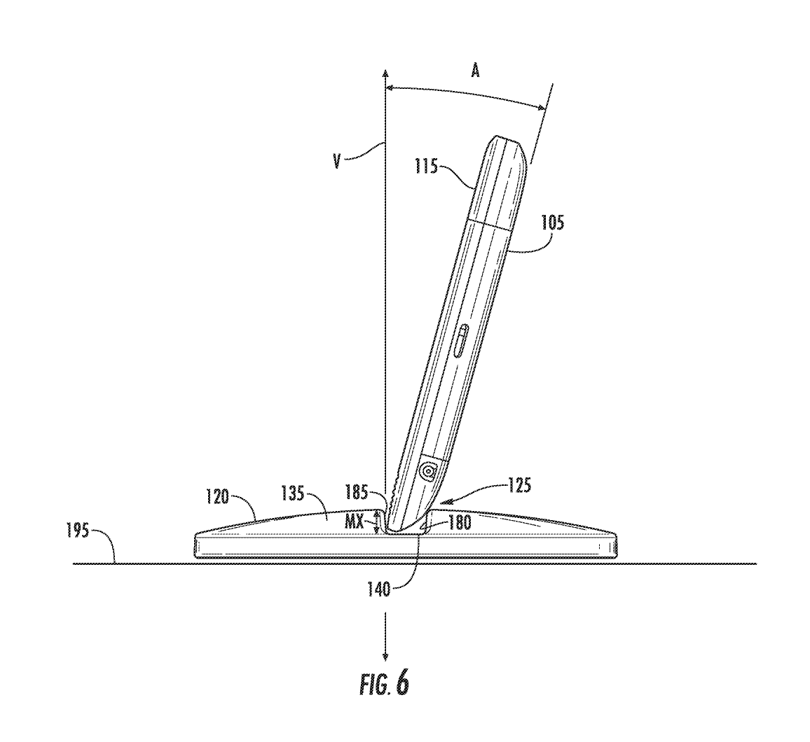

As pointed out above, the support structure 125 can be configured to support the device 105 in a second configuration. An example of this support provided in the second configuration is illustrated in FIGS. 5 and 6. In the second configuration, protective element 120 can be removed from the device 105 and placed on a relatively flat surface 195, with the second surface 135 facing away from the flat surface 195. The support structure 125 can then receive the device 105 and can support the device 105 in a manner, for example, that optimizes the viewing angle of the interface 115. This feature can permit a user to conveniently view information on the interface 115 and can enable or at least improve the operation of one or more other components of the device 105. For example, in one arrangement, the device 105 can be a communication device that can have a camera 200 (see FIG. 5) for conducting video conference calls. Placing the device 105 in the second configuration can permit the camera 200 to capture images of the user in the user's natural sitting or standing position of the device 105 for eventual transmission to another electrical component.

As explained earlier, the support structure 125 can be a slot 140. The dimensions of the slot 140 can be set to achieve the stability of the second configuration and a convenient viewing angle for the device 105. For example, referring to FIG. 6, the width of the slot 140, or the predetermined distance between the first edge 180 and the second edge 185, can be wide enough to receive and support the device 105 in the second configuration so as to induce the device 105 to lean at an angle A in the second configuration. The angle A can be measured with respect to a vertical axis V. As an example, the vertical axis V is a vertical axis of the flat surface 195 on which the protective element 120 sits. In one embodiment but without limitation, the angle A can be within a range of between approximately ten degrees to approximately twenty-five degrees, with a specific example being roughly fifteen degrees. It must be noted, however, that the angle A of the device 105 in the second configuration is not so limited and can be virtually any other angle. In fact, the angle A can be essentially zero with respect to the vertical axis V, meaning that the device 105 can be perpendicular with the flat surface 180.

The width of the slot 140 may not necessarily be the only factor that affects the positioning of the device 105 in the second configuration. Specifically, the maximum height M_{X} (see also FIG. 4) or other shorter heights of the slot 140 may be set to accordingly affect the angle A at which the device 105 will be positioned in the second configuration. For example, the maximum height M_{X} of the slot 140 can be increased to reduce the angle A of the device 105 with respect to the vertical axis V. Conversely, the angle A of the device 105 can be increased by reducing the maximum height M_{X} of the slot 140.

In most scenarios, the interface 115 can be at the same angle A at which the device 105 is positioned with respect to the vertical axis V. Nevertheless, the interface 115 may be positioned at an angle different from the angle A. For example, the interface 115 may be a display that is pivotably coupled to the device 105, which can enable a user to adjust the interface 115 to a desired positioned separate from that of the device 105.

Referring to FIGS. 1, 2 and 4, in addition to being a support for the device 105, the support structure 125 can serve as a grasping mechanism 205 to enable a user to remove the protective apparatus 110 from the device 105 in the first configuration. In particular, the first edge 180, the second edge 185 and the bottom surface 190 of the slot 140 can form the grasping mechanism 205 by providing a space where the user may insert his/her fingers when removing the protective apparatus 110. This feature can provide the user with additional leverage during such a process. As another option, the protective apparatus 110 may be equipped with other structure or components—in addition to the grabbing mechanism 205—to make it easier for the user to remove the protective apparatus 110 from the device 105.

A method of operating the protection and support system 100 will now be presented. In describing this operation, reference will be made to FIGS. 1-6, although it is understood that this method can be practiced with other suitable components and systems. The chronological order of this process is certainly not limited to that described below, either. Moreover, the exemplary method presented here may contain a greater number of or even a fewer number of steps when practiced in other suitable manners.

To start, a user may grasp the protective apparatus 110 and position it over at least a portion of the device 105 such that the protective apparatus is engaged with the device 105 in a first configuration to protect the device 105. An example of this result is shown in FIG. 2. In this state, the device 105 is protected from various detrimental conditions or elements. The user can grasp the protective apparatus 110 once again and can remove the protective apparatus 110 from the device 105, an example of which is shown in FIG. 1. Removing the protective apparatus 110 from the device 105 can include at least partially grasping the slot 140 and lifting the protective apparatus away from the device 105. Next, the user can place the protective apparatus 110 on a surface, like flat surface 195 and can engage the device with the support structure 125 that is integral with the protective apparatus 110. This state is referred to as the second configuration, different views of which are shown in FIGS. 5 and 6. As previously explained, engaging the device 105 with the support structure 125 includes fitting a portion of the device 105 into the slot 140 that is built into the protective apparatus 110. Various processes can be conducted in the second configuration. For example, as explained earlier, a user may conduct a video conference call.

Examples have been described above regarding a protective element and support structure. Various modifications to and departures from the disclosed embodiments will occur to those having skill in the art. The subject matter that is intended to be within the spirit of this disclosure is set forth in the following claims.

What is claimed is:

1. A protective apparatus, comprising:
a protective element configured to be positioned over at least a portion of a device to protect the device in a first configuration; and
a support structure that is integral with the protective element, wherein the support structure is configured to support the device in a second configuration.

2. The protective apparatus according to claim 1, wherein the protective element includes a first surface and a second surface, wherein the first surface is configured to be at least partially positioned over and to face the device in the first configuration and wherein the second surface is positioned opposite to the first surface and is configured to be exposed to the environment external to the device in the first configuration.

3. The protective apparatus according to claim 2, wherein the support structure comprises a slot that runs along the second surface, wherein the slot is configured to receive the device in the second configuration.

4. The protective apparatus according to claim 3, wherein the slot includes a first edge and a second edge opposite to one another, wherein the first edge and the second edge are positioned a predetermined distance apart.

5. The protective apparatus according to claim 4, wherein the predetermined distance is wide enough to receive and support the device in the second configuration and to induce the device to lean at an angle in the second configuration with respect to a vertical axis.

6. The protective apparatus according to claim 1, further comprising one or more border protrusions that are substantially perpendicular to a portion of the first surface.

7. The protective apparatus according to claim 6, wherein the border protrusions are configured to fit over a corresponding perimeter of the device to assist in an engagement between the protective element and the device in the first configuration.

8. The protective apparatus according to claim 6, wherein the second surface of the protective element transitions upwards from the border protrusions of the protective element towards the first edge and the second edge of the slot.

9. The protective apparatus according to claim 4, wherein the slot includes a bottom surface that is substantially planar and further includes a maximum height and a minimum height such that the first edge and the second edge of the slot transition between the maximum height and the minimum height.

10. The protective apparatus according to claim 9, wherein the maximum height of the slot is high enough to support the device in the second configuration by inducing the device to lean at an angle in the second configuration with respect to a vertical axis.

11. The protective apparatus according to claim 3, wherein the first surface includes one or more ribs to support the protective element and the ribs are configured to provide spacing in the first configuration, wherein one of the ribs corresponds to the slot.

12. The protective apparatus according to claim 3, wherein the slot runs the entire second surface and is positioned along a horizontal axis of the protective element.

13. The protective apparatus according to claim 1, wherein the device is a computing device that includes a display.

14. A protective apparatus for protecting a device, comprising:
a first surface that is configured to at least partially fit over and face the device in a first configuration;
a second surface opposite the first surface that is configured to face an external environment in the first configuration; and
a support structure that is integral with the second surface, wherein the support structure is configured to engage and support the device in a second configuration.

15. The protective apparatus according to claim 14, wherein the support structure is a slot that runs along a horizontal axis of the second surface and has a predetermined width.

16. The protective apparatus according to claim 15, wherein the predetermined width of the slot is set to induce the device to lean at an angle in the second configuration, wherein the angle is measured with respect to a vertical axis.

17. The protective apparatus according to claim 16, wherein the angle is within a range of approximately ten degrees to approximately twenty-five degrees.

18. The protective apparatus according to claim 15, wherein the first surface comprises one or more ribs, one of which corresponds to the slot.

19. The protective apparatus according to claim 14, further comprising one or more border protrusions that are configured to engage a corresponding perimeter of the device.

20. The protective apparatus according to claim 19, wherein the border protrusions form a continuous lip that creates a perimeter of the protective apparatus.

21. The protective apparatus according to claim 14, wherein the support structure further provides a grasping mechanism for a user to remove the protective apparatus from the device in the first configuration.

22. The protective apparatus according to claim 21, wherein the support structure comprises a slot integral with the second surface, wherein the slot has a bottom surface, a first edge and a second edge, wherein the bottom surface, the first edge and the second edge form the grasping mechanism of the support structure in the first configuration and engage and support the device in the second configuration.

23. A protection and support system, comprising:
a device that includes an interface for displaying information to a user; and
a protective apparatus configured to protect the device in a first configuration and support the device in a second configuration, wherein the interface displays the information in the second configuration and wherein the protective apparatus comprises:
a first surface that is at least partially positioned over the interface in the first configuration;
a second surface that is exposed to the environment external to the device in the first configuration; and
a support structure integral with the second surface that engages and supports the device in the second configuration.

24. The system according to claim 23, wherein the device is a communication device that includes a camera for conducting video conference calls in the second configuration.

25. The system according to claim 23, wherein the support structure comprises a slot integral with the second surface that induces the device to lean at an angle with respect to a vertical axis, thereby causing the interface to also be positioned at an angle with respect to the vertical axis.

26. The system according to claim 25, wherein the slot has a predetermined width and a maximum height and wherein the dimensions of the predetermined width and maximum height are set to induce the device to lean at the angle.

27. The system according to claim 23, wherein the interface of the device is substantially planar and the first surface includes one or more ribs for engaging the interface in the first configuration.

28. The system according to claim 25, wherein the slot comprises a grasping mechanism to permit a user to remove the protective apparatus from the device in the first configuration.

29. A method of protecting and supporting a device with a protective apparatus, comprising:
positioning the protective apparatus over at least a portion of the device such that the protective apparatus is engaged with the device to protect the device in a first configuration;
removing the protective apparatus from the device;
placing the protective apparatus on a surface; and
in a second configuration, engaging the device with a support structure that is integral with the protective apparatus.

30. The method according to claim 29, wherein engaging the device with the support structure comprises fitting a portion of the device into a slot built into the protective apparatus and wherein the slot induces the device to lean at an angle with respect to a vertical axis.

31. The method according to claim 30, wherein removing the protective apparatus from the device comprises at least partially grasping the slot and lifting the protective apparatus away from the device.

32. The method according to claim 29, further comprising conducting a video conference call in the second configuration.
